(19) United States
(12) Patent Application Publication
(10) Pub. No.: US 2017/0088441 A1
(43) Pub. Date: Mar. 30, 2017

(54) METHOD AND DEVICE FOR DEEP OIL REMOVAL FROM WASTEWATER CONTAINING LOW CONCENTRATION DIRTY OIL

(71) Applicant: East China University of Science and Technology, Shanghai (CN)

(72) Inventors: Qiang YANG, Shanghai (CN); Hao LU, Shanghai (CN); Jiabin ZHU, Shanghai (CN); Xiao XU, Shanghai (CN); Yiqian LIU, Shanghai (CN)

(21) Appl. No.: 15/312,190

(22) PCT Filed: Jul. 21, 2014
(86) PCT No.: PCT/CN2014/000687

§ 371 Date: Nov. 18, 2016

(30) Foreign Application Priority Data
May 19, 2014 (CN) 201410210930.X

(51) Int. Cl. C02F 1/40

(52) U.S. Cl. CPC C02F 1/40; C02F 2101/32

(57) ABSTRACT

The present invention relates to a method and a device for deep oil removal from wastewater containing a low concentration of wasteoil. Wastewater containing a low concentration of wasteoil enters the device via an inlet and passes through a flow conditioner, causing the fluid to become uniformly distributed. Then, by means of a layer of oleophilic-hydrophobic fibers and hydrophilic-oleophobic fibers woven in a certain manner, a trace of oil droplets are captured and then coalesce and grow on the layer, and a trace of oil-in-water emulsion is demulsified and separated on the layer. Finally, by means of corrugation-enhanced sedimentation and separation, the oil droplets coalesce and grow and are then separated rapidly. The invention also provides a set of devices for implementing the method, having several parts such as a housing, a feed pipe, a flow conditioner, a fiber coalescence layer, a corrugation-enhanced separation layer, and a level gauge. The present technique is highly efficient in separation, consumes little power, and can operate continuously for a long period of time. Thus, this technique can be widely used in processes for treating wastewater containing a low concentration of wasteoil.

### FIELD OF THE INVENTION

The present invention relates to environmental protection and oil-water separation, and specifically relates to a method and a device for deep oil removal from wastewater containing a low concentration of wasteoil.

### BACKGROUND OF THE INVENTION

With the increasingly strict requirements on environmental protection, the requirements on deep oil removal from oil-containing wastewater become increasingly high. For example, the upper limit for the oil contained in wastewater produced in offshore oil exploitation in China is lowered to 10 mg/L from the previous 20 mg/L. In addition, the upper limit of the oil contained in the biochemically treated wastewater is also lowered for the wastewater treatment plant.

Due to different sources of the wastewater and different conditions and compositions of the oil, the treatment to the oil-containing wastewater is different in difficulty levels. In terms of the principle, the methods for treating wastewater can be divided into physical methods (such as sedimentation, machinery, centrifuging, coarse graining, filtration and membrane separation), physical-chemical methods (such as flotation, adsorption, ion exchange and electrolysis), chemical methods (such as coagulation, acidification and salting-out), bio-chemical methods (activated sludge, bio-filters and oxidation ponds), and the like.

At present, an oil removal technology using compact flotation unit is mainly adopted to treat the wastewater containing a low concentration of wasteoil. According to a flotation related treatment method, air is introduced into wastewater and is then separated out from water in the form of microbubbles to function as carriers. In this way, contaminants such as the emulsified oil and suspended micro-sized particles in the wastewater adhere(s) to the bubbles and float(s) upwards to the water surface along with the bubbles where foams, namely, a three-phase mixture of air, water and particles (oil), are formed. Finally, foams or scums are collected to separate out impurities so as to purify the wastewater. A flotation related method is mainly used for disposing of emulsified oil or suspended micro-sized particles having a relative density close to 1, wherein the emulsified oil is difficult to remove by natural sedimentation or upward floating. The compact flotation unit (CFU) from Norway Epcon Company is frequently used at present. With respect to the CFU, the rotating centrifugal force and the degassing flotation technology are combined together so that the mass concentration of the contained oil can be generally reduced to 15-20 mg/L. In addition, if two or more units work in parallel, the mass concentration can be as low as 10 mg/L.

However, a lot of factors may influence the flotation no matter which kind of flotation technology is adopted. During the process, what happens first is that bubbles come into contact with oil droplets. Therefore, the particle size of the bubbles, the rising speed of the bubbles and the distribution of the bubbles may all influence the effect of oil removal. Then, after their contacts, the bubbles and the oil droplets should adhere to each other and the oil droplets are enclosed in the bubbles. The state of the fluid in a flotation tank may also influence the flotation effect. For example, separation of bubbles after the adhesion, bubble flowing out of the device along with water and the like will influence the effect. Therefore, the control to the operation is relatively complex. In addition, the energy consumption in the flotation technology is also relatively high. Further, other problems may be subsequently encountered due to the rising of oil droplets along with the air, including the problems regarding liquid-gas separation, gas-liquid separation, and scum disposal.

Chinese invention patent (CN 101972559B) provides an oil-water separation device and an oil-water separation method. The patent discloses three separation methods including rotational flow, coalescence and flotation, which may effectively separate oil from water. However, this device is mainly applied to oil-water separation of crude oil, but not applicable to deep oil removal from wastewater containing a low concentration of wasteoil.

Chinese utility model (200920252001.X) provides a coalescing-plate oil-water separator which is provided with an inlet/outlet and further a coalescence part inside the housing. A demister is arranged at the outlet part. This separator provides a relatively good oil-water separation effect. However, this device is mainly used for pretreating oil-containing wastewater but fails to removing oil from wastewater in a rather thorough manner.

Hence, there is an urgent need to develop an oil removal technology for wastewater containing a low concentration of wasteoil with a low cost, a good effect and a low consumption.

### SUMMARY OF THE INVENTION

In order to overcome the defects of the prior art, the present invention provides a method and a device for deep oil removal from wastewater containing a low concentration of wasteoil. The specified technical solutions are provided as follows.

The present relates to a method for deep oil removal from wastewater containing a low concentration of wasteoil, comprising the steps of

(1) conditioning the flow of wastewater by using a flow conditioner, making the flow uniformly distributed on the radial section on which the fluid flows, wherein the concentration of the wasteoil in the wastewater is no greater than 100 mg/L and the particle size of the oil droplet is 0.1-20 μm;

(2) uniformly flowing the conditioned wastewater through an X-shaped woven layer prepared by staggered weaving of oleophilic-hydrophobic fibers and hydrophilic-oleophobic fibers so as to increase the particle size of the oil droplet to 10-50 μm, wherein in the X-shaped woven layer, oil droplets are captured and then coalesce and grow, and a trace of oil-in-water emulsion is demulsified and separated;

(3) flowing the oil-containing water which has been treated in step (2) through a corrugation-enhanced separation layer so as to reduce the oil content in the wastewater to 8-20 mg/L, wherein the oil droplets grow and are separated rapidly in the corrugation-enhanced separation layer; and

(4) flowing the wastewater which has been treated in step (3) through an Ω-shaped woven layer prepared by weaving oleophilic-hydrophobic fibers and hydrophilic-oleophobic fibers before the wastewater comes into the outlet so as to reduce the oil content in the wastewater to 0.1-8 mg/L, wherein the oil droplets and emulsified oil droplets that have not been separated are concentrated in the Ω-shaped woven layer and then separated from the wastewater.

The flow conditioner is a perforated thick plate in which a plurality of holes is uniformly formed, wherein each hole is round or square. The ratio of the area occupied by the holes to the area of the whole plate is greater than or equal to 60%. In the X-shaped woven layer used in step (2), the included angle between each oleophilic-hydrophobic fiber and the horizontal line ranges from 25 to 60 degrees. One or more X-shaped fiber woven layers fully cover the whole section through which the fluid flows.

The inventor, through long-term study, found the following phenomena. When the included angle between each oleophilic-hydrophobic fiber and the horizontal line (the hydrophilic-oleophobic fiber) is between 25 and 45 degrees, the emulsified oil droplets can be separated in high efficiency. As the included angle between each oleophilic-hydrophobic fiber and each horizontal hydrophilic-oleophobic fiber is relatively small, the emulsified oil droplets (oil in water) are applied with a drag force by the oleophilic-hydrophobic fiber when they move to the joint of two fibers, as shown in FIG. 1, with the polar acting force of the oleophilic-hydrophobic fiber and the hydrophilic-oleophobic fiber. If the angle is relatively small (at position a in FIG. 1), the oil droplets are applied with the force for a relatively long time when the horizontal movement distance is equal. In this respect, the oil droplets can be separated more easily. On the contrary, if the angle is large (at position bin FIG. 1), the oil droplets are not easy to separate as they are applied with the force for a short time. Furthermore, when the included angle between each oleophilic-hydrophobic fiber and the horizontal line is between 45 and 60 degrees, it has a good effect on fast separation of the dispersed oil droplets. Due to the large angle, the oil droplets can rise quickly along with the oleophilic fiber as they move horizontally and are thus separated.

The space a between two adjacent hydrophilic-oleophobic fibers is 1-3 times the space b between two adjacent oleophilic-hydrophobic fibers in the X-shaped woven layer. Due to the relatively small oil content in water, the higher the ratio of the oleophilic fibers occupy, the higher the probability of capturing the oil droplets by the oleophilic fibers will be. Furthermore, as the oil droplets in a relatively low content adhere to the water droplets as micro-particles, the effect will be the best when the space a is controlled to be 1-3 times the space b. If the space a is controlled to be more than 3 times the space b, no obvious increase is found regarding the efficiency. In other words, it makes no sense to increase the percentage occupied by the oleophilic fibers any more, leading to a high cost.

In step (3), the corrugation-enhanced separation layer is made of an oleophilic material, wherein the space between corrugation plates is 5-25 mm. Round holes having a diameter of 5-10 mm are formed at the wave crests, and the space between each two adjacent round holes ranges from 50-300 mm. The oleophilic material enables the floating oil droplets to adhere to and flow on the corrugation plates, and the oil droplets form convergence points at the wave crests so as to float quickly upwards and thus to be separated.

The ratio of the oleophilic-hydrophobic fibers to the hydrophilic-oleophobic fibers in the Ω-shaped woven layer used in step (4) is 3:2 to 7:1. The area of the Ω-shaped woven layer is 30-80% of that of the section through which the fluid flows, and the Ω-shaped woven layer is located at the lower portion of said section. The Ω-shaped woven layer is prepared by arranging the oleophilic-hydrophobic fibers and the hydrophilic-oleophobic fibers in the Ω-shape in advance and then performing the weaving process.

The Ω-shaped woven layer is adopted because of the adsorption effect provided by the oleophilic-hydrophobic fibers. More contact points are formed in the Ω-shaped weaving, and the oleophilic fibers are of a horizontal corrugated shape in the flowing direction of the wastewater. These structures function to guide, draw and adsorb the micro-sized oil droplets and to concentrate and grow the oil droplets when the droplets reach the vertexes. Thus, a much less amount of oil droplets contained in the water flowing towards the outlet are captured and separated, as shown in FIG. 2. That is, the oil is removed in a rather exhaustive manner.

The present invention also relates to a device for implementing any of the above-mentioned methods, comprising a housing, an inlet for oil-containing wastewater, a flow conditioner, a fiber coalescence and separation layer, a corrugation-enhanced separation layer, a fiber coalescence layer, an oil container and an outlet for purified water phase.

In the device, the inlet is located at one end of the upper portion of the housing while the oil container is located at the other end of the upper portion of the housing. The oil container is provided with a level gauge, and an outlet for oil phase is formed on the top of the oil container. The outlet for purified water phase is formed at the lower portion of the housing to be opposite to or slightly deviated from the oil container. The flow conditioner, the fiber coalescence and separation layer, the corrugation-enhanced separation layer and the fiber coalescence layer are located inside the housing and orderly arranged without connecting to each other, wherein the flow conditioner is disposed close to the inlet for oil-containing wastewater. The area of the fiber coalescence layer is 30-80% of that of the section through which the fluid flows, and the fiber coalescence layer is located at the lower portion of said section.

The housing is a horizontal typed cylindrical tank or a horizontal typed cuboid-shaped tank.

The fiber coalescence and separation layer is an X-shaped woven layer prepared by weaving oleophilic-hydrophobic fibers and hydrophilic-oleophobic fibers, wherein an included angle between each oleophilic-hydrophobic fiber and the horizontal line ranges from 25 to 60 degrees.

The fiber coalescence layer is an Ω-shaped woven layer prepared by weaving oleophilic-hydrophobic fibers and hydrophilic-oleophobic fibers, wherein the ratio of the oleophilic-hydrophobic fibers to the hydrophilic-oleophobic fibers is 3:2 to 7:1.

The present invention provides the beneficial effects as follows. The fluid is uniformly distributed: the oleophilic-hydrophobic fibers and the hydrophilic-oleophobic fibers are woven in different combination manners so as to produce the effects of demulsification, coalescence and quick upward floating and separation of the oil droplets; different separation ways are combined in view of the properties of the wastewater containing a trace of oil droplets. In short, the method and the device of the present invention provide a high efficiency and a low consumption, and are applicable to the treatment of wastewater containing a low concentration of wasteoil encountered in different technical fields.

### BRIEF DESCRIPTION OF THE DRAWINGS

FIG. 1 is a schematic diagram showing the principle of demulsification and separation.

FIG. 2 is a schematic diagram showing deep oil removal on an Ω-shaped woven layer.

FIG. 3 is a structural schematic diagram showing an X-shaped woven layer.

FIG. 4 is a schematic diagram showing separation of oil droplets on the X-shaped woven layer.

FIG. 5 is a schematic diagram showing the process for weaving the Ω-shaped woven layer with oleophilic-hydrophobic fibers and hydrophilic-oleophobic fibers.

FIG. 6 is a structural schematic diagram showing a device applicable to deep oil removal from wastewater containing a low concentration of wasteoil.

Symbols are described as follows.

1: housing; 2: inlet for oil-containing wastewater; 3: flow conditioner; 4: X-shaped woven layer; 5: corrugation-enhanced separation layer; 6: oil container; 7: outlet for oil phase; 8: liquid gauge; 9: outlet for purified water phase; 10: Ω-shaped woven layer.

### DETAILED DESCRIPTION OF THE EMBODIMENTS

The present invention is further described below with reference to drawings and the following embodiments.

### Embodiment 1

On the offshore oil platform of one petroleum company for crude oil exploitation, the method and the device of the present invention were adopted which were applicable to deep oil removal from wastewater containing a low concentration of wasteoil. After sedimentation, rotational flow and flotation separation were performed, oil was removed from the wastewater. As a result, the resultant wastewater met the emission standard and was discharged into the sea.

FIG. 6 was the schematic diagram showing the configuration of the device. The device comprised housing 1, inlet for oil-containing wastewater 2, flow conditioner 3, X-shaped woven layer 4 (the fiber coalescence and separation layer), corrugation-enhanced separation layer 5, Ω-shaped woven layer 10 (the fiber coalescence layer), oil container 6, outlet for oil phase 7 and outlet for purified water phase 9. Inlet for oil-containing wastewater 2 was located at one end of the upper portion of housing 1 while oil container 6 was located at the other end of the upper portion of housing 1; oil container 6 was provided with level gauge 8; and outlet for oil phase 7 was formed at the top of oil container 6. Outlet for purified water phase 9 was provided in the lower portion of housing 1 to be opposite to or slightly deviated from oil container 6 which was provided on the upper portion of housing 1. Flow conditioner 3, X-shaped woven layer 4, corrugation-enhanced separation layer 5 and Ω-shaped woven layer 10 were located inside housing 1 and orderly arranged. without connecting to each other, wherein flow conditioner 3 was disposed close to inlet for oil-containing wastewater 2. The area of Ω-shaped woven layer 10 was 30-80% of that of section through which the fluid flowed, and Ω-shaped woven layer was located at the lower portion of the section through which the fluid flowed. Corrugation-enhanced separation layer 5 was made of the oleophilic material, wherein the space between corrugated. plates was 5-25 mm; round holes having the diameter of 5-10 mm were formed at the wave crests, and the space between every two adjacent round holes ranged from 50-300 mm.

Housing 1 as shown in FIG. 6 of the present embodiment was a horizontal typed cylindrical tank or a horizontal typed cuboid-shaped tank.

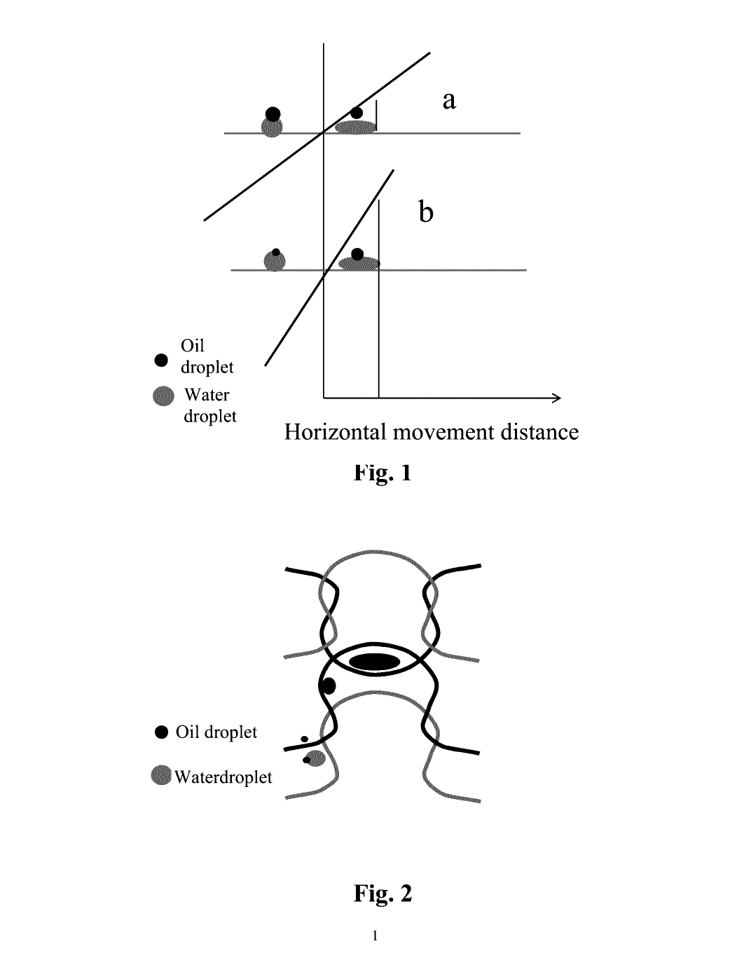

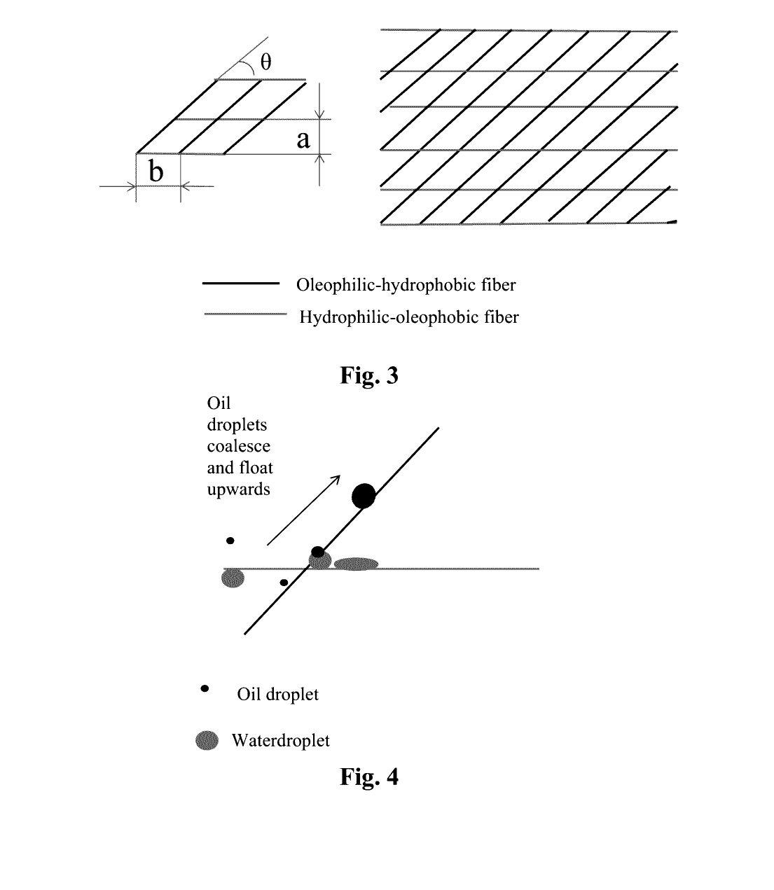

The structure of X-shaped woven layer 4 was shown in FIG. 3, wherein an included angle between each oleophilic-hydrophobic fiber and the horizontal line ranged from 25 to 60 degrees. FIG. 1 was the schematic diagram showing the demulsification and. separation of the fluid on X-shaped woven layer 4, and FIG. 4 was the schematic diagram showing the separation of oil droplets on the X-shaped woven layer 4.

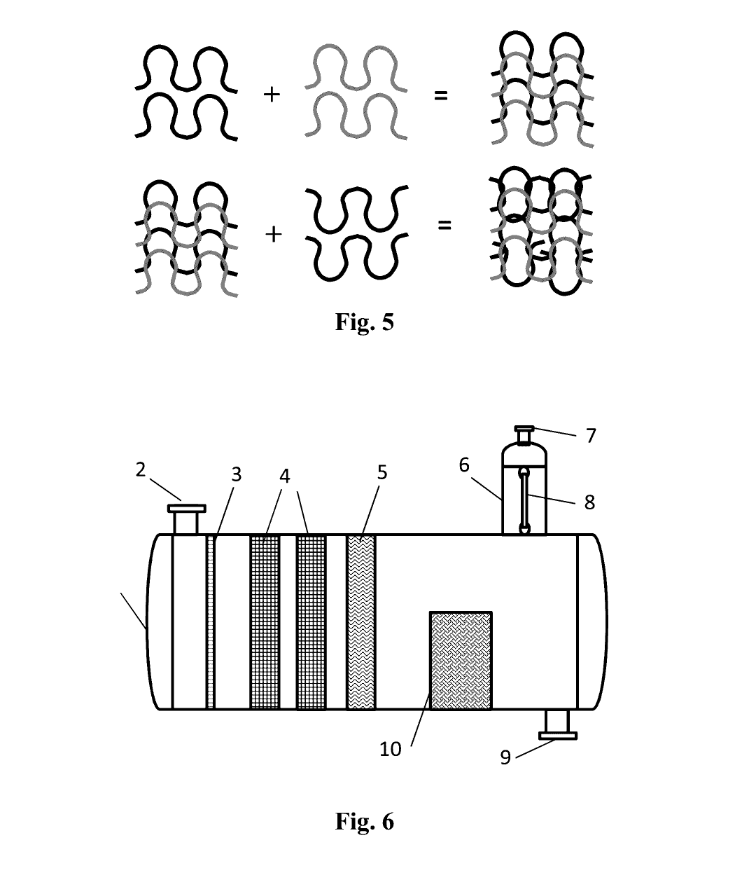

FIG. 2 was the schematic diagram showing deep oil removal on the Ω-shaped woven layer, and FIG. 5 was the schematic diagram showing the process for weaving the Ω-shaped woven layer with the oleophilic-hydrophobic fibers and the hydrophilic-oleophobic fibers, wherein the ratio of the oleophilic-hydrophobic fibers to the hydrophilic-oleophobic fibers was 3:2 to 7:1.

The detailed operation and the effect of deep oil removal by using the device above were as follows.

The Conditions for Treating the Wastewater Produced in the Offshore Oil Platform Wastewater

The operation pressure was 1 psig and the operating temperature was 60-90° C. Further, the oil content in the wastewater was 25-50 mg/L with the particle size of oil being 1-15 μm.

Target to be Achieved

The oil content in the wastewater would be no greater than 10 mg/L after treatment.

Selected Solution

The oil content in the produced wastewater was relatively low. After sedimentation, rotational flow and flotation separation at the preliminary stage, most of the wasteoil contained in the wastewater was dispersed in the wastewater in the form of micro-particles. According to the discharge requirement, the oil content should be stably equal to or lower than 10 mg/L. Therefore, the wastewater was treated by flow conditioning, separation using X-shaped fiber woven layer, corrugation-enhanced separation together with deep separation using Ω-shaped fiber woven layer. In view of the emulsified oil existing in the wastewater, two kinds of the X-shaped fiber woven layer were disposed in order. In the first kind of X-shaped fiber woven layer, the ratio of a to b was 2 and Θ was 25 degrees (as shown in FIG. 3, a referred to the space between two adjacent hydrophilic-oleophobic fibers while b referred to the space between two adjacent oleophilic-hydrophobic fibers, and Θ referred to the included angle between each oleophilic-hydrophobic fiber and the horizontal line). Thus, the first kind of X-shaped fiber woven layer was suitable for efficient and rapid coalescence of small oil droplets and demulsification of emulsified oil droplets. In the second kind of X-shaped fiber woven layer, the ratio of a to b was 1.5 and Θ was 60 degrees. Thus, the second X-shaped fiber woven layer was suitable for quick upward floating and separation of small oil droplets. As the fluid to be discharged required a low oil content, the ratio of the oleophilic-hydrophobic fibers to the hydrophilic-oleophobic fibers in the Ω-shaped fiber woven layer was 4:1. Therefore, the Ω-shaped fiber woven layer was suitable for the concentration and separation of the trace of oil droplets contained in the wastewater.

Result Analysis

The oil content in the purified water at the outlet was 2-6 mg/L and was stably lower than 10 mg/L which was the upper limit of the discharge standard. The pressure at the inlet/outlet was reduced to 0.01 MPa, resulting in decreased energy consumption.

### Embodiment 2

In the wastewater treatment workshop in one oil refinery of a petrochemical company, a device of the present invention was adopted which was applicable to deep oil removal from wastewater containing a low concentration of wasteoil. The oil was pretreated with a sedimentation process and then subjected to this device to remove the oil from the wastewater. As a result, the wastewater obtained from oil removal treatment was ready for the subsequent biochemical treatment.

The conditions were the same as those in Example 1 except for the specific operation process and effect described below.

The Operation Conditions for Treating Wastewater which had Been Pretreated with the Sedimentation Process

The operating pressure was 0.2 MPa and the operating temperature was 40-60° C. In addition, the oil content in the wastewater was 80-100 mg/L.

Target to be Achieved

The oil content in the oil-removed wastewater would be no greater than 25 mg/L.

Selected Solution

The wastewater was simply settled and separated at the preliminary stage, and therefore the oil droplets were mostly dispersed in the wastewater in the form of microsized and/or small particles together with a small amount of emulsified oil droplets. According to the emission requirement, the oil content should be no greater than 25 mg/L. Therefore, the wastewater was treated by flow conditioning, separation using X-shaped fiber woven layer, corrugation-enhanced separation together with deep separation using Ω-shaped fiber woven layer. In view of the emulsified oil existing in the wastewater in a small amount and the oil droplets mostly dispersed in the wastewater in the form of micro-sized and small particles, only one type of the X-shaped fiber woven layer was used, with the ratio of a to b being 2.5 and Θ being 45 degrees. Thus, the X-shaped fiber woven layer was applicable to efficient and rapid coalescence of micro-sized and small oil droplets and demulsification of the small amount of emulsified oil droplets. Also, the X-shaped fiber woven layer enabled quick upward floating and separation of the small oil droplets after they coalesced. As the wastewater would be subject to the biochemical treatment, the oil content should be stably lower than 25 mg/L. Therefore, the ratio of the oleophilic-hydrophobic fibers to the hydrophilic-oleophobic fibers in the Ω-shaped fiber woven layer was 3:1. And the Ω-shaped fiber woven layer was suitable for the separation of the trace of oil droplets from the wastewater in a rather exhaustive manner.

Result Analysis

The oil content in the purified water at the outlet was 14-20 mg/L and was stably lower than 25 mg/L which was the upper limit of the supposed separation requirement. The pressure at the inlet/outlet was reduced to 0.008 MPa, resulting in decreased energy.

In summary, the forgoing descriptions were merely preferred embodiments of the present invention, and the present invention is not limited thereto. Further, equivalent variations and modifications made according to the content of the prevent invention application all fall within the technical scope of the present invention.

What is claimed is:

1. A method for deep oil removal from wastewater containing a low concentration of wasteoil, comprising the steps of:
(1) conditioning the flow of wastewater by using a flow conditioner, making the flow uniformly distributed on the radial section on which the fluid flows, wherein the concentration of the wasteoil in the wastewater is no greater than 100 mg/L and the particle size of the oil droplet is 0.1-20 μm;
(2) uniformly flowing the conditioned wastewater through an X-shaped woven layer prepared by staggered weaving of oleophilic-hydrophobic fibers and hydrophilic-oleophobic fibers so as to increase the particle size of the oil droplet to 10-50 μm, wherein in the X-shaped woven layer, oil droplets are captured and then coalesce and grow, and a trace of oil-in-water emulsion is demulsified and separated;
(3) flowing the oil-containing water which has been treated in step (2) through a corrugation-enhanced separation layer so as to reduce the oil content in the wastewater to 8-20 mg/L, wherein the oil droplets grow and are separated rapidly in the corrugation-enhanced separation layer; and
(4) flowing the wastewater which has been treated in step (3) through an Ω-shaped woven layer prepared by weaving oleophilic-hydrophobic fibers and hydrophilic-oleophobic fibers before the wastewater comes into the outlet so as to reduce the oil content in the wastewater to 0.1-8 mg/L, wherein the oil droplets and emulsified oil droplets that have not been separated are concentrated in the Ω-shaped woven layer and then separated from the wastewater.

2. The method of claim 1, wherein the flow conditioner is a perforated thick plate in which a plurality of holes is uniformly formed with each hole being round or square, and the ratio of the area occupied by the holes to the area of the whole plate is greater than or equal to 60%.

3. The method of claim 1, wherein in the X-shaped woven layer used in step (2), the included angle between each oleophilic-hydrophobic fiber and the horizontal line ranges from 25 to 60 degrees, and one or more X-shaped fiber woven layers fully cover the whole section through which the fluid flows.

4. The method of claim 1, wherein space a between two adjacent hydrophilic-oleophobic fibers is 1-3 times the space b between two adjacent oleophilic-hydrophobic fibers in the X-shaped woven layer.

5. The method of claim 1, wherein the corrugation-enhanced separation layer used in step (3) is made of an oleophilic material, wherein the space between corrugated plates is 5-25 mm, round holes having a diameter within the range of 5-10 mm are formed at the wave crests, and the space between every two adjacent round holes ranges from 50 mm to 300 mm.

6. The method of claim 1, wherein the ratio of the oleophilic-hydrophobic fibers to the hydrophilic-oleophobic fibers in the Ω-shaped woven layer used in step (4) is 3:2 to 7:1, the area of the Ω-shaped woven layer is 30-80% of that of the section through which the fluid flows and the Ω-shaped woven layer is located at the lower portion of said section, and the Ω-shaped woven layer is prepared by arranging the oleophilic-hydrophobic fibers and the hydrophilic-oleophobic fibers in the Ω-shape in advance and then performing the weaving process.

7. A device for implementing the method of any one of claims 1-6, comprising a housing, an inlet for oil-containing wastewater, a flow conditioner, a fiber coalescence and separation layer, a corrugation-enhanced separation layer, a fiber coalescence layer, an oil container and an outlet for purified water phase, wherein the inlet for oil-containing wastewater is located at one end of the upper portion of the housing while the oil container is located at the other end of the upper portion of the housing, the oil container is provided with a level gauge, an outlet for oil phase is formed at the top of the oil container, the outlet for purified water phase is formed in the lower portion of the housing to be opposite to or slightly deviated from the oil container, the flow conditioner, the fiber coalescence and separation layer, the corrugation-enhanced separation layer and the fiber coalescence layer are located inside the housing and orderly arranged without connecting to each other, wherein the flow conditioner is disposed close to the inlet for oil-containing wastewater, the area of the fiber coalescence layer is 30-80% of that of the section through which the fluid flows, and the fiber coalescence layer is located at the lower portion of said section.

8. The device of claim 7, wherein the housing is a horizontal typed cylindrical tank or a horizontal typed cuboid-shaped tank.

9. The device of claim 7, wherein the fiber coalescence and separation layer is an X-shaped woven layer prepared by weaving oleophilic-hydrophobic fibers and hydrophilic-oleophobic fibers, wherein an included angle between each oleophilic-hydrophobic fiber and the horizontal line ranges from 25 to 60 degrees.

10. The device of claim 7, wherein the fiber coalescence layer is an Ω-shaped woven layer prepared by weaving oleophilic-hydrophobic fibers and hydrophilic-oleophobic fibers, wherein the ratio of the oleophilic-hydrophobic fibers to the hydrophilic-oleophobic fibers is 3:2 to 7:1.
